(19) United States
(12) Patent Application Publication
(10) Pub. No.: US 2007/0168535 A1
(43) Pub. Date: Jul. 19, 2007

(54) System and method for data communication between devices

(76) Inventors: Ilmo Ikonen, Tuusula (FI); Andreas Myka, Helsinki (FI); Timo Sinisalmi, Vantaa (FI)

Correspondence Address: MORGAN & FINNEGAN, L.L.P., 3 World Financial Center, New York, NY, 10281-2101, US

(21) Appl. No.: 11/317,947

(22) Filed: Dec. 22, 2005

(51) Int. Cl. G06F 15/16

(52) U.S. Cl. 709/230

(57) ABSTRACT

Systems and methods applicable, for instance, in data communication between devices. A device might, for example, communicate to another device some or all of metadata of one or more objects. The device to which the metadata was communicated might, for instance, further come to possess corresponding object binary data, and/or might perform one or more update operations. One or more reciprocal operations might, for example, be performed.

### FIELD OF INVENTION

This invention relates to systems and methods for data communication between devices.

### BACKGROUND INFORMATION

In recent times, there has been an increase in maintaining information digitally. For example, many individuals have increasing come to employ devices (e.g., wireless nodes and personal computers) to hold their audio, video, image, and communications collections.

Accordingly, there may be interest in technologies applicable, for instance, in such use of devices.

### SUMMARY OF THE INVENTION

According to embodiments of the present invention, there are provided systems and methods applicable, for instance, in data communication between devices.

For example, in various embodiments a device might communicate to another device some or all of metadata of one or more objects. The device to which the metadata was communicated might, in various embodiments, further come to possess corresponding object binary data, and/or might perform one or more update operations.

In various embodiments one or more reciprocal operations might be performed.

### BRIEF DESCRIPTION OF THE DRAWINGS

FIG. 1 shows exemplary steps involved in object selection operations and metadata communication operations according to various embodiments of the present invention.

FIG. 2. shows exemplary steps involved in binary data communication operations, update operations, and reciprocal operations according to various embodiments of the present invention.

FIG. 3 shows exemplary steps involved in move operations according to various embodiments of the present invention.

FIG. 4 shows an exemplary computer.

FIG. 5 shows a further exemplary computer.

### DETAILED DESCRIPTION OF THE INVENTION

General Operation

According to embodiments of the present invention, there are provided systems and methods applicable, for instance, in data communication between devices.

For example, in various embodiments a device might have access to one or more objects that each include metadata and/or binary data.

The device might, in various embodiments, communicate to another device some or all of metadata of one or more of the objects. The communicated metadata might, in various embodiments be the metadata of one or more objects meeting certain criteria. For example, in various embodiments the one or more objects for which metadata is sent might be objects having metadata indicating object change and/or object creation, and/or having timestamp metadata indicating a time later than a time of last synchronization.

The device to which the metadata was communicated might, in various embodiments, further come to possess corresponding object binary data. Possessing metadata and/or binary data, the device to which the metadata was communicated might, in various embodiments, perform one or more update operations.

In various embodiments one or more reciprocal operations might be performed.

Various aspects of the present invention will now be discussed in greater detail.

Object Selection Operations and Metadata Communication Operations

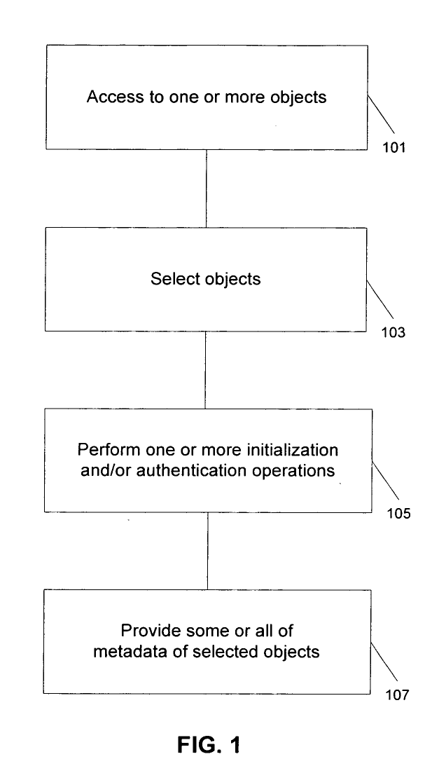

With respect to FIG. 1 it is noted that, according to various embodiments of the present invention, a device (e.g., a wireless node, a mobile communication device, a mobile phone, a personal computer, a set-top box, an audio and/or video recorder (e.g., a digital audio and/or video recorder, a personal storage device, a portable media player and/or recorder, and/or a camcorder and/or digital camera), or any combination thereof) might have access to one or more objects (step 101). Each such object might, for instance, include binary data and/or metadata. Such objects might, for instance, be in an accessible store (e.g., an internal store). It is noted that, in various embodiments, such objects might include thumbnails and/or previews of included binary data.

Such binary data might, for instance, include productivity data (e.g., organizer, word processing, spreadsheet, and/or presentation data), media data (e.g., audio, video, and/or image data), text data, map data, and/or communications data (e.g., email message data, Short Message Service (SMS) data, blog posting data, and/or Multimedia Messaging Service (MMS) data).

Such metadata might, for instance, include object change metadata for the corresponding object, object creation metadata for the corresponding object (e.g., indication of the object being “new” or “not new”), timestamp metadata indicating last synchronization of the corresponding object, metadata indicating synchronization status (e.g., indication of being “synchronized” or “not synchronized”), classification metadata, and/or descriptive metadata. It is noted that, in various embodiments, metadata might be stored in one or more databases (e.g., one or more relational databases) and/or in one or more tables at one or more devices. It is noted that, in various embodiments, some or all metadata might be indicated via one or more flags and/or statues.

It is noted that, in various embodiments, object change metadata and/or object creation metadata might include timestamp information (e.g., information indicating time and/or date of object change, and/or information indicating time and/or date of object creation). Descriptive metadata might, for example, describe corresponding object binary data, include keywords, and/or indicate various characteristics. For instance, such keywords and/or indicated characteristics might be user-specified and/or automatically generated, and/or might regard corresponding object binary data. To illustrate by way of example, in the case where corresponding object binary data was media data, descriptive metadata, such as title, event, topic, and/or location, might include keywords indicating the media to correspond to a user's vacation, and/or might indicate characteristics such as image quality and/or security attributes.

Classification metadata might, for example indicate a corresponding object to be a “favorite” or part of a “timeline”. It is noted that, in various embodiments, objects associated with a certain classification might be considered to exist in a particular folder.

The device might, for example, provide metadata of one or more of the accessible objects to a receiving device. The providing device might, for instance, perform one or more operations to select the objects for which metadata would be sent (step 103).

The receiving device might, for instance, be a device of the sort discussed above. Accordingly, in various embodiments the providing device might be a user's wireless node while the receiving device might be that user's personal computer, and/or vice versa.

The selected objects might, for example, be objects meeting certain criteria. The providing device might, for instance, select objects based on metadata. For instance, the selected objects might be ones having metadata indicating that the objects had been created and/or changed (e.g., since their last synchronization). Such last synchronization might, for instance, be last synchronization of those objects between the providing device and the receiving device (e.g., as indicated by timestamp metadata). It is noted that, in various embodiments, objects so having metadata indicating creation and/or change might be considered to be ones requiring synchronization. It is further noted that, in various embodiments, the providing device might maintain such metadata in a database and/or table.

In various embodiments, all objects of the providing device might be synchronized between the providing device and one or more receiving devices. It is further noted that, in various embodiments, only certain objects of the providing device might be synchronized between the providing device and the receiving device. Accordingly, in various embodiments selection might take into account whether or not objects are ones to be synchronized. Objects to be synchronized might, for instance, be ones being subject to and/or not subject to (e.g., as indicated by metadata) one or more certain classifications. Accordingly, in various embodiments selected objects might be ones having metadata indicating a particular classification (e.g., “favorite”) and/or not indicating a particular classification (e.g., “timeline”). It is noted that, in various embodiments, the selection of objects might be in accordance with a search (e.g., a search performed in conjunctions with an available search function). It is further noted that, in various embodiments, the selection of objects might be in accordance with user choice (e.g., as indicated by a user via a Graphical User Interface (GUI) and/or other interface).

The providing device might, for instance, perform one or more operations to provide to the receiving device some or all of the metadata of the selected objects (step 107). The providing device might, for instance, employ one or more synchronization protocols (e.g., SyncML might be employed) in providing such metadata. It is noted that, in various embodiments, one or more software modules running at the providing device and/or at the receiving device (e.g., one or more synchronization software modules) might act to perform one or more operations including, for example, operations employing on or more synchronization protocols.

It is noted that, in various embodiments, indication of object change (e.g., via object change metadata) might indicate that an object has been deleted. It is further noted that, in various embodiments, as an alterative to and/or in addition to providing to the receiving device metadata for one or more selected objects, the providing device might provide one or more commands to the receiving device. Provision of such commands to the receiving device might, for example, involve use of one or more synchronization protocols (e.g., of the sort discussed above).

Such commands might, for example, include “add”, “change”, and/or “delete”. Such an “add” command might, for instance, indicate that a particular object should be added at the receiving device, such a “change” command might, for instance, indicate that a particular object should be changed at the receiving device, and/or such a “delete” command might, for instance, indicate that a particular object should be deleted at the receiving device.

It is noted that, in various embodiments, one or more initialization and/or authentication operations might be performed (e.g., with commencement of synchronization) (step 105). For example, one or more connections between the providing device and the receiving device might be checked, one or more checks regarding software compatibility between providing device software and receiving device software might be performed (e.g., one or more version compatibility checks), one or more sessions involving synchronization protocol might be created (e.g., one or more SyncML sessions over Object Exchange (OBEX)), and/or one or more synchronization initialization messages might be sent (e.g., from the receiving device to the providing device, and/or from the providing device to the receiving device).

It is further noted that, in various embodiments, one or more synchronization method negotiation operations might be performed (e.g., with commencement of synchronization). For example, the providing device might send one or more synchronization anchors, one or more maximum and/or minimum message sizes (e.g., SyncML message sizes), and/or one or more synchronization type requests (e.g., requests for fast synchronization and/or for slow synchronization) to the receiving device, the receiving device might determine (e.g., taking into account received synchronization anchors and/or requests) synchronization type to be employed (e.g., fast synchronization or slow synchronization), the receiving device might send to the providing device indication of synchronization mode to be used, one or more maximum and/or minimum message sizes (e.g., of the sort discussed above), and/or one or more new synchronization anchor confirmations, and/or the providing device might comply with one or more received message sizes if capable, and/or might comply as closely as possible if not capable (e.g., the providing device might employ as large a message size as possible if not capable of a maximum message size indicated by the receiving device).

It is noted that maximum and/or minimum message sizes indicated by the receiving device might, for example, be derived in view of sizes sent by the providing device. It is additionally noted that, in various embodiments, various of the synchronization method negotiation operations discussed above as being performed by the providing device may instead be performed by the receiving device, and vice versa. Fast synchronization and slow synchronization will be discussed in further detail below.

According to various embodiments of the present invention, the synchronization type to be employed might be determined in a manner taking into account synchronization anchors. Such synchronization anchors might, for instance, be exchanged between the providing device and the receiving device. It is noted that, according to various embodiments, there might be a “last” synchronization anchor and a “next” synchronization anchor. The “last” synchronization anchor might, in various embodiments, describe the last synchronization between the providing device and the receiving device, while the “next” synchronization anchor might, in various embodiments, describe the synchronization between the providing device and the receiving device to occur once synchronization type to be employed has been negotiated. Communication between the providing device and the receiving device for purposes of negotiating synchronization type to be employed might, in various embodiments, employ a synchronization protocol (e.g., of the sort discussed above).

To illustrate by way of example it is noted that the receiving device might, in various embodiments, receive “last” and/or “next” anchors from the providing device. The receiving device might, for instance, echo back the received “next” anchor to the providing device. Such echoing might, for example, be performed via a status of alert command (e.g., a SyncML-compliant status of alert command).

One or more software modules (e.g., a synchronization module) running at the receiving device might, for instance, compare the “last” synchronization anchor received from the providing device with the “last” synchronization anchor that it already possessed. In the case where the “last” synchronization anchors were found to be identical, fast synchronization might be employed, whereas otherwise slow synchronization might be employed. The receiving device might, for instance, store the received “next” synchronization anchor to an accessible store. It is noted that, in various embodiments, this stored “next” synchronization anchor might act as the “last” synchronization anchor for the next synchronization.

With synchronization mode to employ having been determined, the receiving device might, for example, indicate to the providing device the determined synchronization type, one or more desired maximum message sizes, and/or confirmation of synchronization anchors provided by the providing device. The providing device might, for example, in turn echo back to the receiving device one or more of the indicated items. Such echoing might, for instance, be performed via a status of alert command (e.g., of the sort discussed above).

In various embodiments, in the case where there is a communication failure between the two devices (e.g., during the just-described indication of items by the receiving device and/or the just-described echoing back by the providing device), a failure flag (e.g., a “synchronization failed” flag) might be stored at the receiving device, and/or slow synchronization might be employed for the next synchronization between the providing device and the receiving device without there being anchor comparison.

Moreover, in various embodiments in the case where there is some sort of failure at the providing device before synchronization starts, it might indicate to the receiving device a desire for slow synchronization. The providing device might do so, for instance, by sending a special alert code (e.g., a SyncML-compliant alert code) to the receiving device, perhaps along with one or more synchronization anchors of the providing device.

It is noted that, in various embodiments, operations discussed in this illustrative example as being performed by the providing device may instead be performed by the receiving device, and vice versa.

In various embodiments, the providing device might (e.g., with commencement of synchronization) start to fill a message with device information regarding itself (e.g., SyncML-compliant device information), a status object (e.g., a SyncML status object), metadata of one or more objects, and/or one or more commands. Such a status object might, in various embodiments, be sent only once per synchronization. Having filled the message, the providing device might, for instance, send it to the receiving device. In various embodiments, in the case where the providing device had additional information to send to the receiving device that did not fit in the message (e.g., metadata of one or more objects, and/or one or more commands), the providing device might employ, as necessary, one or more subsequent messages to convey the information.

It is further noted that, in various embodiments, operations at the providing device and/or at the receiving device might act such that “favorite” objects are visible (e.g., via a GUI and/or other interface) at both the providing device and at the receiving device as both “favorites” and as part of a timeline. Alternately or additionally, operations at the providing device and/or at the receiving device might, in various embodiments, act such that objects that are not “favorites” as visible (e.g., via GUI and/or other interface) only as part of a timeline at the receiving device, and not visible at the providing device.

Such operations might, in various embodiments, be performed by one or more software modules running at the providing device and/or at the receiving device.

It is noted that, in various embodiments, metadata may be held in one or more databases and/or in one or more tables at the providing device, at the receiving device, and/or at other devices (e.g., remote devices).

Binary Data Communication Operations

According to various embodiments of the present invention, one or more operations might be performed communicating some or all of binary data of the selected objects from the providing device to the receiving device.

The receiving device might, for example, determine the object binary data that it desired to possess, and provide indication of such (e.g., via a synchronization protocol of the sort discussed above) to the to the providing device. Accordingly, for example, the receiving device might indicate to the providing device one or more of the selected objects to be ones for which corresponding binary data was desired. The receiving device might so indicate, for example, via a synchronization protocol (e.g., of the sort discussed above.

In response the providing device might, for example, dispatch such binary data to the receiving device. Such dispatch might, in various embodiments, be performed in a manner employing protocol or protocols different from protocol or protocols employed to provide the metadata to the receiving device. For example, in various embodiments one or more file transfer protocols (e.g., OBEX File Transfer Profile, File Transfer Protocol (FTP), and/or Hypertext Transfer Protocol (HTTP)) might be employed. It is noted that, in various embodiments, one or more software modules running at the providing device and/or at the receiving device (e.g., one or more file transfer software modules) might act to perform one or more operations including, for example, operations employing one or more file transfer protocols.

As another example, in various embodiments the providing device might provide binary data corresponding to the selected objects to the receiving device without receiving any request for such from the receiving device. Accordingly, for instance, the providing device might provide to the receiving device some or all of the binary data of all of the selected objects without receiving any request for such from the receiving device. Provision of binary data might, for instance, be performed in a manner employing protocol or protocols different from protocol or protocols employed to provide the metadata to the receiving device (e.g., one or more file transfer protocols of the sort discussed above might be employed). The receiving device might, in various embodiments, move received binary data to another location in the case where it was not already in the correct location as originally received.

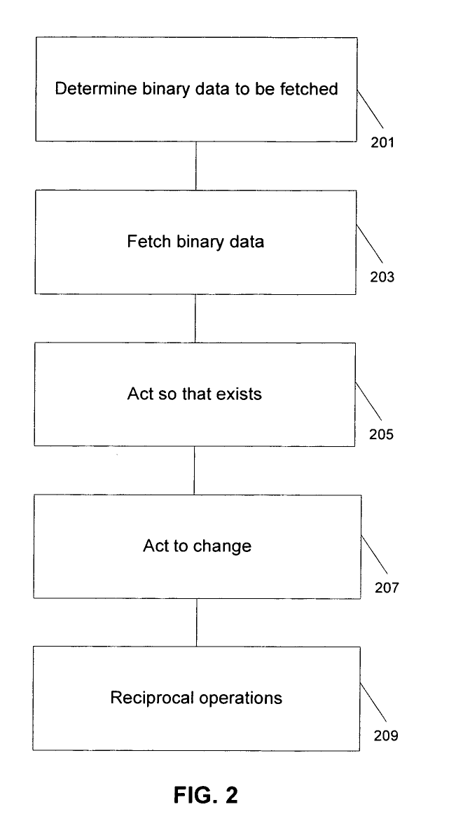

With respect to FIG. 2 it is noted that, as yet another example, the receiving device might act to fetch from the providing device some or all of the binary data of the selected objects (step 203). The receiving device might, for instance, perform one or more operations to determine the binary data to be fetched (step 201) (e.g., to determine one or more of the selected objects for which corresponding binary data would be fetched). Fetching of the binary data might, in various embodiments, be performed in a manner employing protocol or protocols different from protocol or protocols employed to provide the metadata to the receiving device (e.g., one or more file transfer protocols of the sort discussed above might be employed).

The functionality by which the receiving device determines binary data to be indicated to the providing device as desired binary data, and/or determines the binary data to be fetched, might be implemented in a number of ways. In various embodiments, such determination might involve one or more conflict resolution operations, and/or consideration of metadata.

For example the receiving device might act such that the binary data that it indicates as desired to the providing device and/or fetches from the providing device is binary data corresponding to all selected objects except those whose object change metadata included timestamp data indicating change prior to change to those objects as they existed at the receiving device.

To illustrate by way of example, suppose that a particular object existed at both the providing device and the receiving device, and had been changed at both devices since last synchronization of the object between the two devices. In the case where the receiving device received from the providing device object change metadata, including timestamp data, corresponding to the object as it existed at the providing device, and the receiving device found that timestamp data to indicate a time prior to a time indicated by object change metadata, including timestamp data, corresponding to the object as it existed at the receiving device, the receiving device might determine that binary data corresponding to the object as it existed at the providing device was not desired. Accordingly, the receiving device might, for instance, neither indicate to the providing device that it desired such binary data, nor fetch such binary data.

In various embodiments synchronization operations between the providing device and the receiving device receiving device might involve the use of one or more synchronization protocols (e.g., of the sort discussed above), with one or more file transfer protocols (e.g., of the sort discussed above) being employed for binary data communication.

It is noted that, in various embodiments, operations employing synchronization protocol may be performed in parallel with operations employing file transfer protocol. In various embodiments, two parallel OBEX connections between the providing device and the receiving device might be employed (e.g., one OBEX connection for operations employing file synchronization protocol, and another OBEX connection for operations employing file transfer protocol. OBEX connections between the providing device and the receiving device might be implemented in a number of ways. For instance, OBEX connection might employ a wired connection (e.g., Universal Serial Bus (USB)) and/or a wireless connection (e.g., Bluetooth, Infrared Data Association (IrDA), and/or Wireless Fidelity (WiFi)).

It is further noted that, in various embodiments, various synchronization communications may be carried out using Extensible Markup Language (XML), such XML perhaps being binary encoded and/or Wireless Application Protocol (WAP) encoded. For example, in various embodiments Wireless Binary XML (WBXML) might be employed. Accordingly, for example, metadata dispatch might employ WBXML.

It is additionally noted that, in various embodiments, the providing device might act as a synchronization client (e.g., a SyncML client), while the receiving device might act as a synchronization server (e.g., a SyncML server). Alternately or additionally, the opposite might, in various embodiments, be true. Moreover, in various embodiments the providing device might act as an OBEX server while the receiving device might act as an OBEX client. Alternately or additionally, the opposite might, in various embodiments, be true.

In various embodiments, the receiving device might act upon, in turn, one or more received commands and/or received metadata sent via messages (e.g., of the sort discussed above) from the providing device. As discussed above, in various embodiments the receiving device may come to possess corresponding binary data. Moreover, in various embodiments, one or more objects might be deleted at the providing device.

Moreover, in various embodiments the receiving device might provide one or more messages regarding performed operations to the providing device. Such messages might, for instance, be responses to received commands and/or metadata. The receiving device might, for example, add such commands to a message, and send the message to the providing device once either the message was full or there was nothing more regarding performed operations to send to the providing device. In various embodiments, in the case where there was more regarding performed operations to send than fit in a message, one or more subsequent messages might, as necessary, be employed. The receiving device might, for example, fill messages with information regarding performed operations while performing such operations, and/or subsequent to performance of such operations.

It is noted that, in various embodiments, in the case where the receiving device, while performing such operations, receives a new message from the providing device with additional commands and/or metadata, the receiving device might perform operations regarding the newly-received additional commands and/or metadata subsequent to completion of operations regarding previously-received additional commands and/or metadata. Alternately or additionally, operations regarding the newly-received additional commands and/or metadata might be performed prior to and/or concurrently with operations regarding previously-received additional commands and/or metadata.

Receiving information regarding performed operations, the providing device might, in various embodiments, continue to send messages of the sort discussed above to the receiving device. In the case where there is no more to be sent to the receiving device, the providing device might, for example, send a final tag (e.g., a SyncML-compliant final tag) to the receiving device.

Receiving (e.g., via a message sent from the receiving device) indication that the receiving device is full, the providing device might, in various embodiments, continue to send messages of the sort discussed above in the case where there is still additional information (e.g., additional commands and/or metadata) to send to the receiving device, and/or the providing device might only send to the receiving device requests for information regarding performed operations in the case where, for instance, there are not additional commands and/or metadata to send.

It is noted that, in various embodiments, in the case where the receiving device, instead of receiving metadata for a particular object, determined and/or received indication (e.g., from the providing device) that there was no metadata for that object, the receiving device might act in a manner analogous to that discussed above where object metadata indicates change or creation.

Update Operations and Reciprocal Operations

According to various embodiments of the present invention, the receiving device might employ object metadata and/or object binary data that it came to possess to perform one or more update operations.

With further respect to FIG. 2 it is noted that, for example, in the case where the receiving device came to possess metadata indicating that an object had been created at the providing device since last synchronization, the receiving device might act to employ corresponding metadata and/or binary data that it came to possess in acting so that the object exists at itself (step 205). Accordingly, in various embodiments the receiving device might perform one or more object creation objects to create (e.g., in an accessible store) an object corresponding to the object created at the providing device.

As another example, in the case where the receiving device came to possess metadata indicating that an object had been changed at the providing device since last synchronization, with the receiving device perhaps further determining that such change was subsequent to any change of the corresponding object as it existed at itself, the receiving device might act to change the object as it exists at itself (step 207).

The receiving device might, for example, act responsive to object creation and/or change at the providing device such that the object as it existed at the receiving device came to have identical metadata and/or binary data to that that it came to possess from the providing device. As another example, the receiving device might act to alter such metadata and/or binary data. For instance, the receiving device might alter such metadata to include a timestamp indicating when the object came to exist at the receiving device via synchronization or when the object came to be changed via synchronization.

In various embodiments indication of object change (e.g., via object change metadata) might indicate that an object had been deleted. Accordingly, in various embodiments, change of an object as it existed at the receiving device might involve deletion of the object as it existed at the receiving device. It is noted that such deletion might, for example, involve removal of the object from a store. As another example, such deletion might involve retention of the object but indication (e.g., via metadata) that the object was considered to be deleted.

It is noted that although operation is discussed herein wherein binary data comes to be possessed after coming to possess corresponding metadata, in various embodiments binary data may come to be possessed prior to and/or at the same time as coming to possess corresponding metadata. For instance, in various embodiments metadata might come to be possessed subsequent to coming to possess corresponding binary data in the case where there is no request for the binary data and/or for the metadata.

It is noted that, in various embodiments, the receiving device may act to match metadata and binary data that it has come to possess, and/or to organize the binary data according to the metadata.

Various exemplary metadata operations according to various embodiments of the present invention will now be described. For example, in various embodiments in the case where a new object is created and/or received, its metadata might indicate a status of “new”. As another example, in various embodiments in the case where such a “new” object is modified, its metadata might still indicate a status of “new”. As another example, in various embodiments in the case where an object of one device comes to be possessed by another device, metadata for the object (e.g., at either device or at both devices) might indicate a status of “synchronized”.

As yet another example, in various embodiments in the case a “synchronized” object is changed, object change metadata for the object might indicate such. As another example, in various embodiments in the case where an object for which metadata indicates change is further changed, its metadata might still indicate change.

As an additional example, in various embodiments in the case where an object whose metadata indicates a status of “new” is deleted, corresponding metadata may be removed (e.g., from one or more databases and/or tables. As a further example, in various embodiments in the case where an object whose metadata indicates “synchronized” and/or change is deleted, indication of such may be stored, and/or metadata and/or binary data for the object may be eliminated. For example, a identifier of the object may be stored. Such storage might, for instance, be in a database and/or table. Such a database and/or table might, in various embodiments, be a “delete” database and/or table for holding such information.

In various embodiments, the receiving device may act to determine if an object is a new object or an updated object, and/or to perform metadata update. Such might occur, for instance, where selection of objects is, perhaps as discussed above, in accordance with user choice.

According to various embodiments, synchronization may occur among multiple devices. It is noted that, in various such embodiments, metadata information (e.g., flags and/or statuses) might be device-specific. Alternately or additionally, in various embodiments different devices may have different synchronized content.

It is noted that, according to various embodiments, the receiving device may report back to the providing device (e.g., via a synchronization protocol of the sort discussed above) successful completion of one or more update operations.

In various embodiments, one or more reciprocal operations may be performed (step 209). Accordingly, for instance, in various embodiments one or more operations discussed above as being performed by the providing device might be performed by the receiving device, and vice versa.

Accordingly, in various embodiments the receiving device might, perhaps in a manner analogous to that discussed above, perform one or more reciprocal operations. For example, the receiving device might, perhaps in a manner analogous to that discussed above, have access to one or more objects (e.g., of the sort discussed above), select one or more of those objects, send to the providing device metadata corresponding to the selected objects, and/or act in communicating some or all of the corresponding binary data to the providing device (e.g., with or without there being request for such binary data).

Moreover, in various embodiments, the providing device might, perhaps in a manner analogous to that discussed above, perform one or more reciprocal operations. For example, the providing device might, perhaps in a manner analogous to that discussed above, come to possess object metadata from the receiving device, come to possess object binary data (perhaps after having acted to determine object binary data that it desired to possess), and/or perform one or more update operations.

It is noted that, in various embodiments, via the above-discussed operations and/or the above-discussed reciprocal operations, one or more objects might, for instance, be synchronized between the two devices.

It is noted that, in various embodiments, as one of such reciprocal operations the receiving device might, for instance, send a final tag (e.g., of the sort discussed above) to the providing device. Receiving such a final tag the providing device might, for instance, send such a final tag to the receiving device. The receiving device might, for example, in turn send a last such final tag to the providing device. With sending of the last final tag, synchronization might, in various embodiments, be considered to be complete.

Fast synchronization and slow synchronization will now be discussed in greater detail. Fast synchronization may, according to various embodiments, involve the receiving device adding, to a list of objects to be sent to the providing device, objects added at the providing device since last synchronization. Such objects might, for example, be ones associated with certain classification metadata (e.g., such objects might be ones considered to be favorites).

The providing device might, in various embodiments, possess a snapshot of Locally Unique Identifiers (LUIDs) and/or timestamps of objects that it possessed at the time of last synchronization. The providing device, with commencement of a synchronization employing fast synchronization, might, for example, create a new such snapshot and compare it to the old one. Via such comparison the providing device might, for instance, create a list of all of its objects that were to be synchronized with the receiving device. Such a created list might, in various embodiments, include only objects reflected in the new snapshot but not reflected in the old snapshot. With the lists created at the providing device and at the receiving device, synchronization might, in various embodiments, commence.

Slow synchronization might, in various embodiments, involve no creations of lists as discussed above with respect to fast synchronization, and instead, for instance, involve iteration through each object at the providing device and/or iteration through each object at the receiving device.

It is noted that, in various embodiments, various of the fast synchronization and/or slow synchronization operations discussed above as being performed by the providing device may instead be performed by the receiving device, and vice versa.

Cancellation Operations

According to various embodiments of the present invention, operations might be performed to cancel synchronization under various circumstances. Such functionality might, for instance, be implemented so as to terminate synchronization at an early stage (e.g., before any communication of object metadata and/or binary data). In various embodiments, in the case where synchronization is cancelled, user notification might be provided (e.g., via a GUI and/or other interface of the providing device and/or of the receiving device), with the notification perhaps conveying one or more reasons for the cancellation.

For example, synchronization might be cancelled in the case where connection between the providing device and the receiving device cannot be established. Such functionality might, for example, involve determining that there is no synchronization already going on. Such functionality might be implemented in a number of ways. For instance, the receiving device might act to determine how many data synchronization connections (e.g., OBEX data synchronization connections) there were between the providing device and the receiving device. Such determination might, for instance, involve communication with one or more software modules (e.g., via communication with a local connectivity layer software module).

In the case, for instance, where it was determined that there were no such connections, synchronization might not be cancelled. In the case for instance, where it was determined that there were one or more such connections and/or that no such determination could be made (e.g., in the case where one or more consulted software modules did not respond), synchronization might be cancelled.

Functionality where synchronization is cancelled in the case where connection between the providing device and the receiving device cannot be established might, alternately or additionally, involve verifying that the receiving device can establish a file transfer protocol connection (e.g., OBEX File Transfer Profile protocol connection) with the providing device, and/or vice versa. Such functionality might be implemented in a number of ways. For instance, the receiving device might employ a software module (e.g., a file transfer software module) to create a file transfer protocol connection (e.g., of the sort discussed above), and to perform one or more operations via the connection (e.g., a change directory operation might be attempted). To illustrate by way of example, the receiving device might attempt to create a file transfer protocol connection using an Bluetooth or USB. In various embodiments, in the case where the connection is successfully established and the one or more operations are successfully performed, synchronization might not be cancelled, while where such is not the case synchronization might be cancelled.

As another example of synchronization cancellation, synchronization might be cancelled in the case where one or more software version compatibility checks failed. Such functionality might be implemented in a number of ways. For example, one or more appropriate software modules running at the providing device and one or more appropriate software modules running at the receiving device might communicate with one another to determine that each is running software compatible with the other in terms of software version. As further examples, files of the providing device and/or of the receiving device indicating software version might be consulted. For example, The receiving device might (e.g., via one or more file transfer protocols of the sort discussed above) examine such a file existing at the providing device to determine if appropriate software running at the providing device was compatible with appropriate software running at the receiving device. It is noted that, in various embodiments, the receiving device might provide to the providing device (e.g., via one or more file transfer protocols of the sort discussed above) one or more files indicating one or more software versions of appropriate software running at the receiving device.

Such one or more files might, for example, be provided to the providing device by the receiving device at the beginning of synchronization and/or be removed by the providing device after being consulted by the providing device. Such consultation by the providing device might, in various embodiments, involve consideration of one or more versions indicated by the one or more files in view of one or more version values received from the receiving device. Moreover, such consultation by the providing device might, for example, be performed after receiving one or more synchronization initialization messages from the receiving device. Consultation by the providing device might, in various embodiments, need to successfully complete in order for synchronization to not be cancelled.

It is noted that, in various embodiments, one or more device version and/or firmware version checks might be performed at the providing device and/or at the receiving device, with synchronization perhaps only not being cancelled in the case where one or more acceptable version values were found at the providing device and/or at the receiving device, and/or where device and/or firmware version compatibility check yielded results indicating compatibility. Such version compatibility might, for example, involve device and/or firmware versions at the providing device being compatible with device and/or firmware versions at the receiving device. Alternately or additionally, such version compatibility might involve one or more firmware versions at the providing device being compatible with one or more device versions at that device, and/or one or more firmware versions at the receiving device being compatible with one or more device versions at that device.

It is noted that, in various embodiments, one or more file transfer protocol connections employed for software version compatibility checks might be ones established previously (e.g., via one or more connection establishment tests of the sort discussed above). Alternately or additionally, file transfer protocol connections employed for software version compatibility checks might be newly established.

In various embodiments, with one or more software version compatibility checks failing synchronization might be cancelled, whereas with software version compatibility checks providing results indicating compatibility synchronization might not be cancelled.

As yet another example of synchronization cancellation, synchronization might be cancelled in the case where one or more authentication checks failed. Such functionality might be implemented in a number of ways. For example, one or more software modules running at the receiving device (e.g., a synchronization software module) might act to determine if the providing device was a “primary” device. As another example, one or more software modules running at the receiving device (e.g., a local connectivity layer software module) might act to query (e.g., via a GUI and/or other interface of the receiving device) a user to accept connection with the providing device in the case where the providing device is not defined as a trusted device. As yet another example, one or more software modules running at the providing device (e.g., a local connectivity layer software module) might act to query (e.g., via a GUI and/or other interface of the providing device) a user to accept connection with the receiving device in the case where the receiving device is not defined as a trusted device. As a further example, determination of a proper synchronization profile (e.g., SyncML profile) being present at the receiving device and/or at the receiving device might be performed.

Such “primary” device determination might be performed in a number of ways. For instance, the providing device and/or the receiving device might act to receive a list of the devices connected to it, the list perhaps indicating for each listed device identifying information such as Media Access Control (MAC) address, Bluetooth address, and/or International Mobile Equipment Identity (IMEI) number. Such operation might, for instance involve a synchronization software module running at the providing device communicating with a local connectivity layer software module of that device, and/or a synchronization software module running at the receiving device communicating with a local connectivity layer software module of that device. In various embodiments, in the case where a listed device was the one that was used for the last synchronization performed (e.g., as indicated by an accessible store), that listed device might be considered to be a “primary” device.

In various embodiments, in the case where no “primary” device is found, a user might need to provide additional information for the check to not be considered to have failed. For example, a user might need to select one or more of the devices manually from the list (e.g., via a GUI and/or other interface of the providing device and/or of the receiving device) in order for the check to not be considered to have failed.

The above-discussed user querying might, in various embodiments, occur one or more times. For instance, such might occur with determination of whether or not connection between the providing device and the receiving device can be established, with establishment of connection between a software module (e.g., a synchronization software module) running at the providing device and a software module (e.g., a synchronization software module) running at the receiving device, when establishing file transfer protocol connection from the receiving device to the providing device, and/or when establishing file transfer protocol connection from the providing device to the receiving device. In various embodiments, in the case where a user does not respond to the querying in a manner accepting connection, the check may be considered to have failed.

The above discussed determination of proper synchronization profile might, in various embodiments, involve communication among one or more software modules (e.g., a synchronization software module) of the providing device and one or more software modules of the receiving device (e.g., a synchronization software module). Such communication might, for instance, involve the receiving device sending a string to the providing device (e.g., in a synchronization initialization message) and the providing device seeing if this string matched a string that it held, and/or the providing device sending a string to the receiving device (e.g., in a synchronization initialization message) and the receiving device seeing if this string matched a string that it held. Such a string might, in various embodiments, provide a Uniform Resource Locator (URL) indicating synchronization profile location. In various embodiments, in the case where a favorable result was not found (e.g., where there was not string match), the check may be considered to have failed.

In various embodiments, with one or more authentication checks failing synchronization may be cancelled, whereas with authentication checks providing positive results synchronization might not be cancelled.

Moreover, in various embodiments, in the case where one or more of the foregoing cancellation operations were performed, but no failures occurred, synchronization might proceed, while with one or more failures synchronization might be cancelled.

Move Operations

According to various embodiments of the present invention, one or more move operations might be performed. Such operations might, for example, be performed in a manner similar to that discussed above, but additionally including deletion of an object at the providing device.

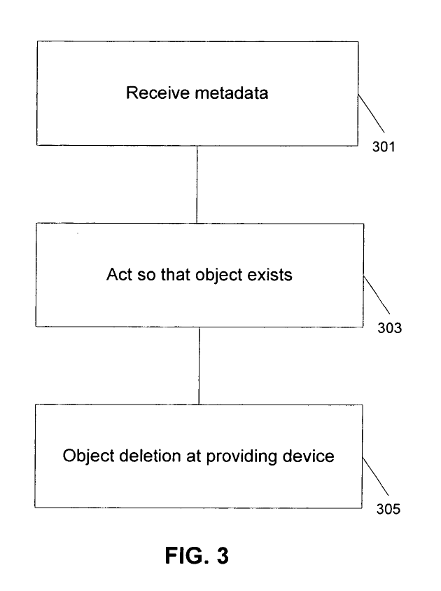

With respect to FIG. 3 it is noted that, for example, such operations might be performed in a manner similar to that discussed above with respect to the receiving device, having received metadata indicating that an object has been created at the providing device since last synchronization (step 301), acting so that the object exists at itself (step 303), but additionally including deletion of the object at the providing device (step 305).

Such deletion functionality might be implemented in a number of ways. As examples, the receiving device might send (e.g., via one or more synchronization protocols of the sort discussed above) one or more commands to the providing device indicating that deletion should occur, the receiving device might access an accessible store of the providing device so as to perform deletion, and/or the providing device might perform deletion with satisfaction of one or more criteria (e.g., with all data of the appropriate object being sent to and/or successfully received by receiving device, and/or with passage of a certain amount of time).

Such operations might, for instance, be performed with respect to objects that had been created at the providing device since last synchronization in the case where classification metadata of those objects conveyed particular information. For example, in various embodiments such operations might be performed in the case where such classification metadata did not indicate those objects to be “favorite” objects, and/or where such classification metadata indicated those objects to be “timeline” objects.

It is noted that, in various embodiments, the receiving device might not receive and/or might not take into consideration metadata indicating that an object has been created at the providing device since last synchronization. For example, operation might be performed such that an appropriate object exists at the receiving device but is deleted from the providing device in the case where the receiving device comes to possess classification metadata for that object indicating the object to not be a “favorite” and/or to be a “timeline” object, and/or where the receiving device receives a “move” command corresponding to the object.

Functionality wherein an object comes to exist at the receiving device but is deleted from the providing device might, for example, be employed in the case where the providing device was a device considered (e.g., by a user, manufacturer, and/or system administrator) to have limited storage capability (e.g., a wireless node considered to have limited storage capability), and the receiving device was a device considered (e.g., by a user, manufacturer, and/or system administrator) to have greater storage capability (e.g., a personal computer).

Application of such functionality under such circumstances might, in various embodiments, help prevent a user from overwhelming the storage capacity of her limited storage capability device, while allowing her to maintain possession of her objects via their being moved to her greater storage capability device.

In various embodiments, deletion might, perhaps in a manner analogous to that discussed above, involve object removal (e.g., from a store) and/or or object retention (e.g., with indication that the object was considered to be deleted).

It is noted that although move from the providing device to the receiving device has been discussed, move functionality might, in various embodiments, alternately or additionally allow for move from the receiving device to the providing device.

Hardware and Software

Various operations and/or the like described herein may, in various embodiments, be executed by and/or with the help of computers. Further, for example, devices and/or items described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal sever, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or Net.

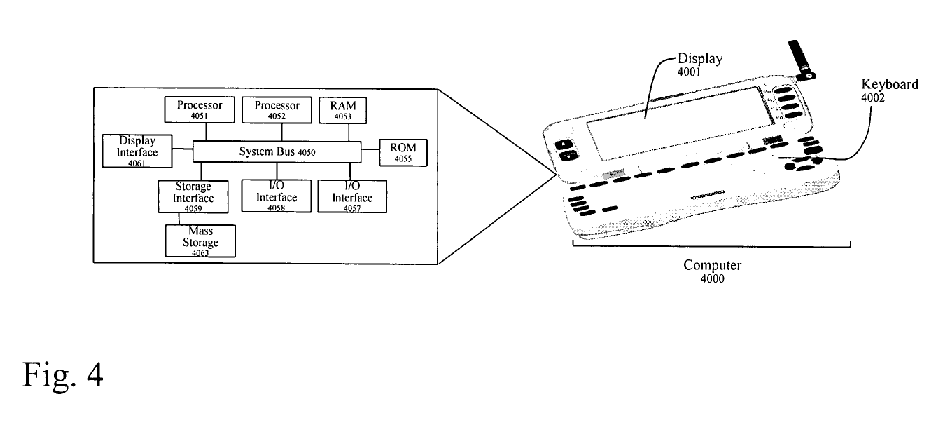

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 4 is an exemplary computer employable in various embodiments of the present invention. Exemplary computer 4000 (e.g., a providing device or receiving device of the sort discussed herein), includes system bus 4050 which operatively connects two processors 4051 and 4052, random access memory 4053, read-only memory 4055, input output (I/O) interfaces 4057 and 4058, storage interface 4059, and display interface 4061. Storage interface 4059 in turn connects to mass storage 4063. Each of I/O interfaces 4057 and 4058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 4063 may be a hard drive, optical drive, a memory chip, or the like. Processors 4051 and 4052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, or an IBM, Toshiba, or Sony Cell processor. Computer 4000 as shown in this example also includes a touch screen 4001 and a keyboard 4002. In various embodiments, a mouse, keypad, and/or interface might alternately or additionally be employed. Computer 4000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

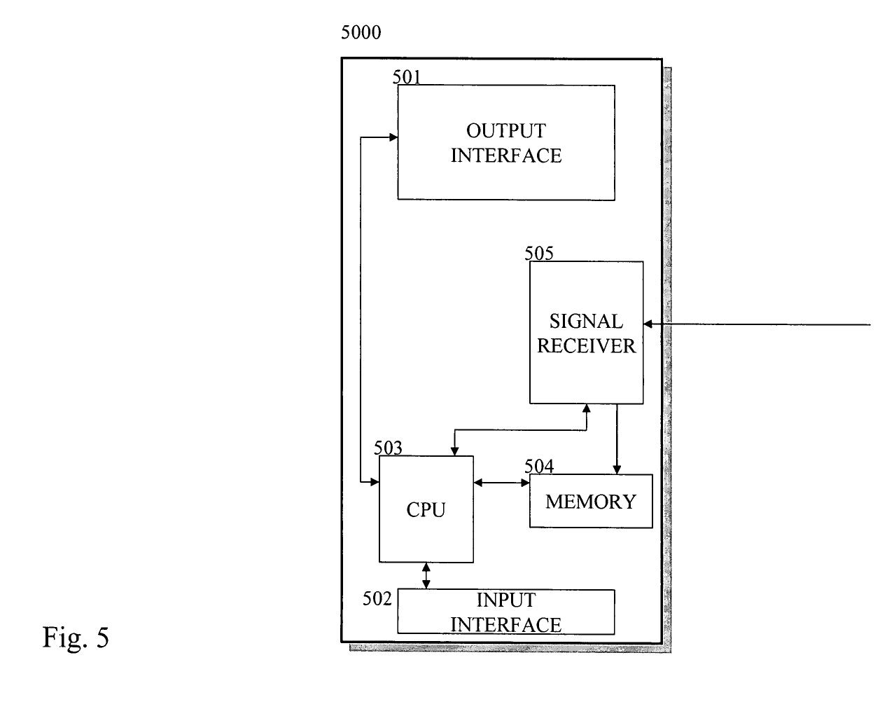

Shown in FIG. 5 is a block diagram of a terminal, an exemplary computer (e.g., a providing device or receiving device of the sort discussed herein) employable in various embodiments of the present invention. In the following, corresponding reference signs are applied to corresponding parts. Exemplary terminal 5000 of FIG. 5 comprises a processing unit CPU 503, a signal receiver 505, and a user interface (501, 502). Signal receiver 505 may, for example, be a single-carrier or multi-carrier receiver. Signal receiver 505 and the user interface (501, 502) are coupled with the processing unit CPU 503. One or more direct memory access (DMA) channels may exist between multi-carrier signal terminal part 505 and memory 504. The user interface (501, 502) comprises a display and a keyboard to enable a user to use the terminal 5000. In addition, the user interface (501, 502) comprises a microphone and a speaker for receiving and producing audio signals. The user interface (501, 502) may also comprise voice recognition (not shown).

The processing unit CPU 503 comprises a microprocessor (not shown), memory 504 and possibly software. The software can be stored in the memory 504. The microprocessor controls, on the basis of the software, the operation of the terminal 5000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 5, alternatively, middleware or software implementation can be applied. The terminal 5000 can, for instance, be a hand-held device which a user can comfortably carry. The terminal 5000 can, for example, be a cellular mobile phone which comprises the multi-carrier signal terminal part 505 for receiving multicast transmission streams. Therefore, the terminal 5000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
receiving at a first device from a second device, via a first protocol, metadata corresponding to one or more objects of one or more selected objects, wherein the selected objects are one or more objects requiring synchronization, and wherein the selected objects are selected by the second device; and
coming to possess at the first device from the second device, via a second protocol, binary data corresponding to the one or more objects of the selected objects,
wherein the first protocol is a synchronization protocol and the second protocol is a file transfer protocol.

2. The method of claim 1, wherein the synchronization protocol is syncml.

3. The method of claim 1, wherein the file transfer protocol is object exchange file transfer profile protocol.

4. The method of claim 1, wherein one or more of the selected objects are indicated to be favorites via metadata.

5. The method of claim 1, wherein one or more of the selected objects have corresponding metadata indicating creation subsequent to a last synchronization.

6. The method of claim 1, wherein one or more of the selected objects have corresponding metadata indicating change subsequent to a last synchronization.

7. The method of claim 1, further comprising performing, at the first device, one or more update operations.

8. The method of claim 1, wherein the second device performs one or more reciprocal operations.

9. The method of claim 1, wherein the first device is a personal computer.

10. The method of claim 1, wherein the second device is a wireless node.

11. A method, comprising:
selecting, at a first device, one or more objects requiring synchronization;
communicating from the first device to a second device, via a first protocol, metadata corresponding to one or more of the selected objects; and
communicating from the first device to the second device, via a second protocol, binary data corresponding to the one or more of the selected objects,
wherein the first protocol is a synchronization protocol and the second protocol is a file transfer protocol.

12. The method of claim 11, wherein the synchronization protocol is syncml.

13. The method of claim 11, wherein the file transfer protocol is object exchange file transfer profile protocol.

14. The method of claim 11, wherein one or more of the selected objects are indicated to be favorites via metadata.

15. The method of claim 11, wherein one or more of the selected objects have corresponding metadata indicating creation subsequent to a last synchronization.

16. The method of claim 11, wherein one or more of the selected objects have corresponding metadata indicating change subsequent to a last synchronization.

17. The method of claim 11, wherein the second device performs one or more update operations.

18. The method of claim 11, further comprising performing, at the first device, one or more reciprocal operations.

19. The method of claim 11, wherein the first device is a wireless node.

20. The method of claim 11, wherein the second device is a personal computer.

21. A system, comprising:
a memory having program code stored therein; and
a processor disposed in communication with the memory for carrying out instructions in accordance with the stored program code;
wherein the program code, when executed by the processor, causes the processor to perform:
receiving at a first device from a second device, via a first protocol, metadata corresponding to one or more objects of one or more selected objects, wherein the selected objects are one or more objects requiring synchronization, and wherein the selected objects are selected by the second device; and
coming to possess at the first device from the second device, via a second protocol, binary data corresponding to the one or more objects of the selected objects,
wherein the first protocol is a synchronization protocol and the second protocol is a file transfer protocol.

22. The system of claim 21, wherein the synchronization protocol is syncml.

23. The system of claim 21, wherein the file transfer protocol is object exchange file transfer profile protocol.

24. The system of claim 21, wherein one or more of the selected objects are indicated to be favorites via metadata.

25. The system of claim 21, wherein one or more of the selected objects have corresponding metadata indicating creation subsequent to a last synchronization.

26. The system of claim 21, wherein one or more of the selected objects have corresponding metadata indicating change subsequent to a last synchronization.

27. The system of claim 21, wherein the processor further performs:
performing, at the first device, one or more update operations.

28. The system of claim 21, wherein the second device performs one or more reciprocal operations.

29. The system of claim 21, wherein the first device is a personal computer.

30. The system of claim 21, wherein the second device is a wireless node.

31. A system, comprising:
a memory having program code stored therein; and
a processor disposed in communication with the memory for carrying out instructions in accordance with the stored program code;
wherein the program code, when executed by the processor, causes the processor to perform:
selecting, at a first device, one or more objects requiring synchronization;
communicating from the first device to a second device, via a first protocol, metadata corresponding to one or more of the selected objects; and
communicating from the first device to the second device, via a second protocol, binary data corresponding to the one or more of the selected objects,
wherein the first protocol is a synchronization protocol and the second protocol is a file transfer protocol.

32. The system of claim 31, wherein the synchronization protocol is syncml.

33. The system of claim 31, wherein the file transfer protocol is object exchange file transfer profile protocol.

34. The system of claim 31, wherein one or more of the selected objects are indicated to be favorites via metadata.

35. The system of claim 31, wherein one or more of the selected objects have corresponding metadata indicating creation subsequent to a last synchronization.

36. The system of claim 31, wherein one or more of the selected objects have corresponding metadata indicating change subsequent to a last synchronization.

37. The system of claim 31, wherein the second device performs one or more update operations.

38. The system of claim 31, wherein the processor further performs:
performing, at the first device, one or more reciprocal operations.

39. The system of claim 31, wherein the first device is a wireless node.

40. The system of claim 31, wherein the second device is a personal computer.

41. A device, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
receiving from a second device, via a first protocol, metadata corresponding to one or more objects of one or more selected objects, wherein the selected objects are one or more objects requiring synchronization, and wherein the selected objects are selected by the second device; and
coming to possess from the second device, via a second protocol, binary data corresponding to the one or more objects of the selected objects,
wherein the first protocol is a synchronization protocol and the second protocol is a file transfer protocol.

42. A device, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
selecting one or more objects requiring synchronization;
communicating to a second device, via a first protocol, metadata corresponding to one or more of the selected objects; and
communicating to the second device, via a second protocol, binary data corresponding to the one or more of the selected objects,
wherein the first protocol is a synchronization protocol and the second protocol is a file transfer protocol.

43. An article of manufacture comprising a computer readable medium containing program code that when executed causes a device to perform:
receiving from a second device, via a first protocol, metadata corresponding to one or more objects of one or more selected objects, wherein the selected objects are one or more objects requiring synchronization, and wherein the selected objects are selected by the second device; and
coming to possess from the second device, via a second protocol, binary data corresponding to the one or more objects of the selected objects,
wherein the first protocol is a synchronization protocol and the second protocol is a file transfer protocol.

44. An article of manufacture comprising a computer readable medium containing program code that when executed causes a device to perform:
selecting one or more objects requiring synchronization;
communicating to a second device, via a first protocol, metadata corresponding to one or more of the selected objects; and
communicating to the second device, via a second protocol, binary data corresponding to the one or more of the selected objects,
wherein the first protocol is a synchronization protocol and the second protocol is a file transfer protocol.
